(19) United States
(12) Patent Application Publication
(10) Pub. No.: US 2024/0192990 A1
(43) Pub. Date: Jun. 13, 2024

(54) DEVICE FOR DETERMINING EXECUTION ORDER OF PLURALITY OF TASKS, OPERATION METHOD AND PROGRAM FOR DEVICE FOR DETERMINING EXECUTION ORDER, DEVICE FOR GENERATING PLURALITY OF MACHINE LEARNING MODELS, LEARNING DEVICE, AND PREDICTION DEVICE

(71) Applicant: FUJIFILM CORPORATION, Tokyo (JP)

(72) Inventors: Shotaro MISAWA, Tokyo (JP); Ryuji KANO, Tokyo (JP); Tomoki TANIGUCHI, Tokyo (JP); Tomoko OHKUMA, Tokyo (JP); Hirokazu YARIMIZU, Tokyo (JP); Kohei ONODA, Tokyo (JP)

(21) Appl. No.: 18/582,663

(22) Filed: Feb. 21, 2024

Related U.S. Application Data
(63) Continuation of application No. PCT/JP2022/031882, filed on Aug. 24, 2022.

(30) Foreign Application Priority Data
Aug. 25, 2021 (JP) 2021-137516

(51) Int. Cl. G06F 9/48

(52) U.S. Cl. CPC G06F 9/4881

(57) ABSTRACT

There is provided a device for determining an execution order of a plurality of tasks, the device including: processor; and a memory connected to or built in the processor, in which the processor is configured to execute execution order determination processing of determining an execution order of the plurality of tasks under a condition that an output of at least one task of the tasks is input to the task in a subsequent stage.

### CROSS-REFERENCE TO RELATED APPLICATIONS

This application is a continuation of International Application No. PCT/JP2022/031882, filed on Aug. 24, 2022, which claims priority from Japanese Application No. 2021-137516, filed on Aug. 25, 2021. The entire disclosure of each of the above applications is incorporated herein by reference.

### BACKGROUND

### Technical Field

The present disclosure relates to a device for determining an execution order of a plurality of tasks, an operation method and a program for a device for determining an execution order, a device for generating a plurality of machine learning models, a learning device, and a prediction device.

### Related Art

By connecting a plurality of machine learning models corresponding to a plurality of tasks and executing training, it is possible to perform advanced information processing that cannot be achieved by a single machine learning model. For example, JP2021-58464A discloses a technique for generating a first learning model corresponding to a task of specifying a polyp candidate from an endoscopic image of a large intestine and generating a second learning model having higher accuracy from an output of the first learning model.

In a case where there are a plurality of tasks, by appropriately setting an execution order of the plurality of tasks and inputting an output of a previous stage to a subsequent stage, prediction accuracy for one or a plurality of tasks may be improved as compared with a case where each task is independently executed.

For example, it is considered that there is a case where a first task for predicting a hospitalization period of a patient based on medical data and a second task for predicting a rehospitalization rate of a patient based on medical data are present. In this case, by inputting an output of a machine learning model for solving the first task to a machine learning model for solving the second task, it is expected that at least the prediction accuracy of the machine learning model in a subsequent stage is improved as compared with a case where each machine learning model is independently executed.

However, in a case where there are a large number of tasks, it is difficult for a person to determine an appropriate execution order.

### SUMMARY

According to the present disclosure, there is provided a device for determining an execution order of a plurality of tasks, the device capable of determining an execution order of a plurality of tasks, such that prediction accuracy of one or a plurality of tasks is improved as compared with a case where each task is independently executed.

According to a first aspect of the present disclosure, there is provided a device for determining the execution order of a plurality of tasks, the device including: processor; and a memory connected to or built in the processor, in which the processor is configured to execute execution order determination processing of determining the execution order of the plurality of tasks under a condition that an output of at least one task of the tasks is input to the task in a subsequent stage.

According to a second aspect of the present disclosure, in the first aspect, the plurality of tasks may include a first task and a second task, and in the execution order determination processing, the processor may be configured to: create, for each of the correct answer labels of the first task, a frequency distribution of each of the correct answer labels of the second task by using a training data set, and calculate a first statistic based on the frequency distribution; create, for each of correct answer labels of the second task, a frequency distribution of each of correct answer labels of the first task by using a training data set, and calculate a second statistic based on the frequency distribution; and determine the execution order of the plurality of tasks based on the first statistic and the second statistic.

According to a third aspect of the present disclosure, in the first aspect, in the execution order determination processing, the processor may be configured to extract a plurality of order patterns that are considered for the plurality of tasks, generate a plurality of provisional models for respectively solving the plurality of tasks according to each of the extracted order patterns, and determine the execution order of the plurality of tasks based on a result obtained by training the plurality of provisional models and evaluating prediction accuracy.

According to a fourth aspect of the present disclosure, in the third aspect, in the execution order determination processing, the processor may be configured to, in a case of training the plurality of provisional models, input an output of at least one provisional model of the provisional models to the provisional model in a subsequent stage.

According to a fifth aspect of the present disclosure, in the third aspect, in the execution order determination processing, the processor may be configured to, in a case of training the plurality of provisional models, input a correct answer label corresponding to an output of at least one provisional model of the provisional models to the provisional model in a subsequent stage.

According to a sixth aspect of the present disclosure, in any one aspect of the first aspect to the fifth aspect, the processor may be configured to further execute display processing of displaying the execution order on a display unit.

According to a seventh aspect of the present disclosure, in any one aspect of the first aspect to the sixth aspect, in the execution order determination processing, the processor may be configured to determine the execution order in consideration of an execution order designated by a user.

According to an eighth aspect of the present disclosure, in any one aspect of the first aspect to the seventh aspect, in the execution order determination processing, the processor may be configured to automatically define an auxiliary task for predicting information that is not determined at a time of performing prediction.

According to a ninth aspect of the present disclosure, in any one aspect of the first aspect to the eighth aspect, the output of at least one task of the tasks may be a numerical value obtained by regression.

According to a tenth aspect of the present disclosure, in any one aspect of the first aspect to the eighth aspect, the output of at least one task of the tasks may be a result of classification.

According to an eleventh aspect of the present disclosure, in any one aspect of the first aspect to the eighth aspect, the output of at least one task of the tasks may be a probability value obtained in a classification process.

Further, according to a twelfth aspect of the present disclosure, there is provided a device for generating a plurality of machine learning models, the device including: a processor; and a memory connected to or built in the processor, in which the processor is configured to execute model generation processing of generating a plurality of machine learning models for respectively solving the plurality of tasks according to the execution order determined by the device for determining an execution order according to the first aspect to the eleventh aspect.

Further, according to a thirteenth aspect of the present disclosure, there is provided a learning device of a plurality of machine learning models, the device including: a processor; and a memory connected to or built in the processor, in which the processor is configured to execute training processing of connecting and training the plurality of machine learning models according to the execution order determined by the device for determining an execution order according to the first aspect to the eleventh aspect.

According to a fourteenth aspect of the present disclosure, in the thirteenth aspect, the plurality of machine learning models may be deep learning models based on a neural network, and in the training processing, the processor may be configured to train the plurality of machine learning models while propagating an error of the machine learning model in a subsequent stage to the machine learning model in a previous stage.

According to a fifteenth aspect of the present disclosure, in the thirteenth aspect, the plurality of machine learning models may be deep learning models based on a neural network, and in the training processing, the processor may be configured to train the plurality of machine learning models without propagating an error of the machine learning model in a subsequent stage to the machine learning model in a previous stage.

According to a sixteenth aspect of the present disclosure, in the thirteenth aspect, in the training processing, the processor may be configured to train the machine learning model in a subsequent stage after training the machine learning model in a previous stage and confirming the machine learning model.

According to a seventeenth aspect of the present disclosure, in any one aspect of the thirteenth aspect to the sixteenth aspect, the plurality of machine learning models may include a common model, and in the training processing, the processor may be configured to combine and change a configuration of the common model.

Further, according to an eighteenth aspect of the present disclosure, there is provided a prediction device of a plurality of machine learning models, the device including: a processor; and a memory connected to or built in the processor, in which the processor is configured to execute prediction processing of connecting the plurality of machine learning models and causing the plurality of machine learning models to perform prediction according to the execution order determined by the device for determining an execution order according to the first aspect to the eleventh aspect.

Further, according to a nineteenth aspect of the present disclosure, there is provided an operation method for a device for determining an execution order of a plurality of tasks, the method including: a step of determining an execution order of the plurality of tasks under a condition that an output of at least one task of the tasks is input to the task in a subsequent stage.

Further, according to a twentieth aspect of the present disclosure, there is provided a program that determines an execution order of a plurality of tasks, the program causing a computer to execute a process including: a step of determining an execution order of the plurality of tasks under a condition that an output of at least one task of the tasks is input to the task in a subsequent stage.

### BRIEF DESCRIPTION OF THE DRAWINGS

FIG. 1 is a diagram illustrating a schematic configuration of a prognosis prediction system according to an exemplary embodiment 1.

FIG. 2 is a block diagram illustrating a hardware configuration of a prediction server according to the exemplary embodiment 1.

FIG. 3A is a diagram illustrating a functional configuration of the prediction server according to the exemplary embodiment 1.

FIG. 3B is a diagram illustrating a functional configuration of the prediction server according to the exemplary embodiment 1.

FIG. 4 is a diagram illustrating an example of training data sets according to the exemplary embodiment 1.

FIG. 5 is a diagram illustrating an example of medical data according to the exemplary embodiment 1.

FIG. 6 is a flowchart illustrating details of processing performed by an execution order determination unit according to the exemplary embodiment 1.

FIG. 7 is a diagram illustrating an example of a pair of tasks extracted in the exemplary embodiment 1.

FIG. 8 is a diagram illustrating an example of a histogram of a first frequency distribution created in the exemplary embodiment 1.

FIG. 9 is a diagram illustrating an example of a histogram of a second frequency distribution created in the exemplary embodiment 1.

FIG. 10 is a diagram illustrating an example of an evaluation table created in the exemplary embodiment 1.

FIG. 11 is a diagram illustrating an example of a configuration of a machine learning model generated in the exemplary embodiment 1 at a time of training.

FIG. 12 is a diagram illustrating an example of a configuration of a machine learning model generated in the exemplary embodiment 1 at a time of prediction.

FIG. 13 is a diagram illustrating an example of a configuration of an auxiliary task in the exemplary embodiment 1.

FIG. 14A is a diagram illustrating an example of a learning method of an auxiliary task in the exemplary embodiment 1.

FIG. 14B is a diagram illustrating an example of a learning method of an auxiliary task in the exemplary embodiment 1.

FIG. 15 is a diagram illustrating a configuration example of a common part included in a plurality of machine learning models in the exemplary embodiment 1.

FIG. 16A is a diagram illustrating a configuration of a prediction server according to an exemplary embodiment 2.

FIG. 16B is a diagram illustrating a configuration of a prediction server according to an exemplary embodiment 2.

FIG. 17 is a flowchart illustrating details of processing performed by an execution order determination unit according to the exemplary embodiment 2.

FIG. 18 is a diagram illustrating an example of order patterns of tasks extracted in the exemplary embodiment 2.

FIG. 19 is a diagram illustrating an example of an evaluation table created in the exemplary embodiment 2.

### DESCRIPTION

Hereinafter, in exemplary embodiments of the present disclosure, an example in which a technical idea of the present disclosure is applied to a prognosis prediction system that predicts a prognosis of an inpatient based on medical data of the inpatient will be described with reference to the accompanying drawings. Here, a scope to which the technical idea of the present disclosure can be applied is not limited thereto. Further, in addition to the disclosed exemplary embodiments, various forms that can be implemented by those skilled in the art are within the scope of the claims.

### Exemplary Embodiment 1

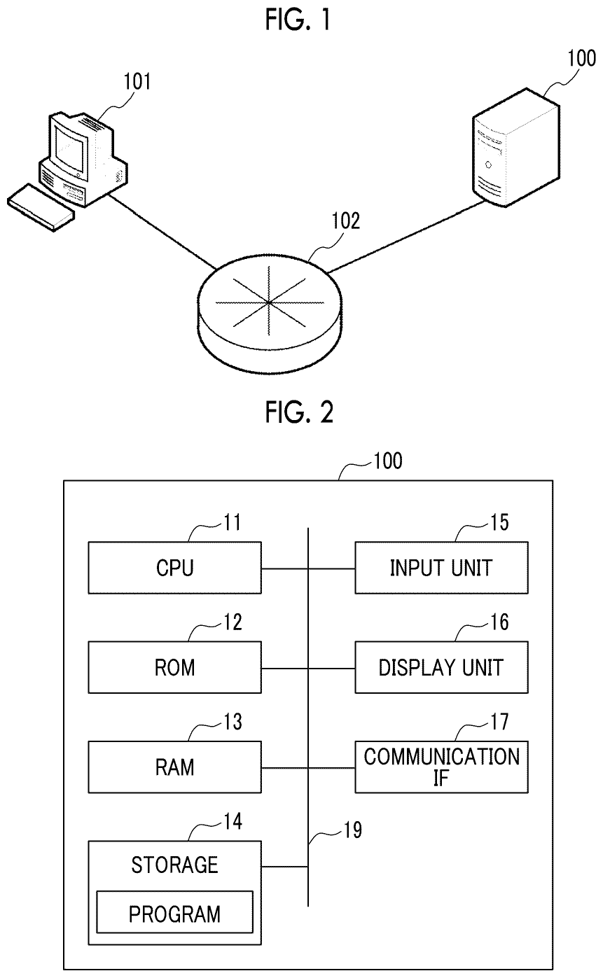

FIG. 1 is a diagram illustrating a schematic configuration of a prognosis prediction system according to an exemplary embodiment 1 of the present disclosure. The prognosis prediction system includes a prediction server 100, a user terminal 101, and a communication line 102 that connects the prediction server 100 and the user terminal 101 to each other for communication.

The prediction server 100 predicts a prognosis of an inpatient based on medical data of the inpatient that is transmitted from the user terminal 101 via the communication line 102. The prediction server 100 returns a predicted prognosis of the patient to the user terminal 101 via the communication line 102.

The user terminal 101 is a well-known personal computer. The communication line 102 is the Internet, an intranet, or the like. The communication line 102 may be a wired line or a wireless line. In addition, the communication line 102 may be a dedicated line or a public line.

FIG. 2 is a block diagram illustrating a hardware configuration of the prediction server 100. The prediction server 100 includes a central processing unit (CPU) 11, a read only memory (ROM) 12, a random access memory (RAM) 13, a storage 14, an input unit 15, a display unit 16, and a communication interface 17. The hardware components are communicably connected to each other via a bus 19.

The CPU 11 is a central arithmetic processing unit. The CPU 11 reads a program stored in the ROM 12 or the storage 14, and executes the program by using the RAM 13 as a work area. In the present exemplary embodiment 1, the ROM 12 or the storage 14 stores a program for predicting a hospitalization period of a patient based on medical data of the patient.

The ROM 12 stores various programs and various types of data. The RAM 13 as a work area temporarily stores the program or the data. The storage 14 is configured with a storage device such as a hard disk drive (HDD), a solid state disk (SSD), or a flash memory, and stores various programs including an operating system and various types of data.

The input unit 15 is configured with a mouse, a keyboard, and the like, and is used in a case where a user inputs data to the prediction server 100.

The display unit 16 is, for example, a liquid crystal display panel, and is used in a case where the prediction server 100 presents information to the user. Note that the display unit 16 and the input unit 15 may be implemented in common by adopting a touch-panel-type liquid crystal display panel.

The communication interface 17 is an interface that allows the prediction server 100 to perform communication with another device such as the user terminal 101. As a standard of the communication interface 17, for example, Ethernet (registered trademark), a fiber distributed data interface (FDDI), or Wi-Fi (registered trademark) can be adopted.

### Functional Configuration of Prediction Server 100

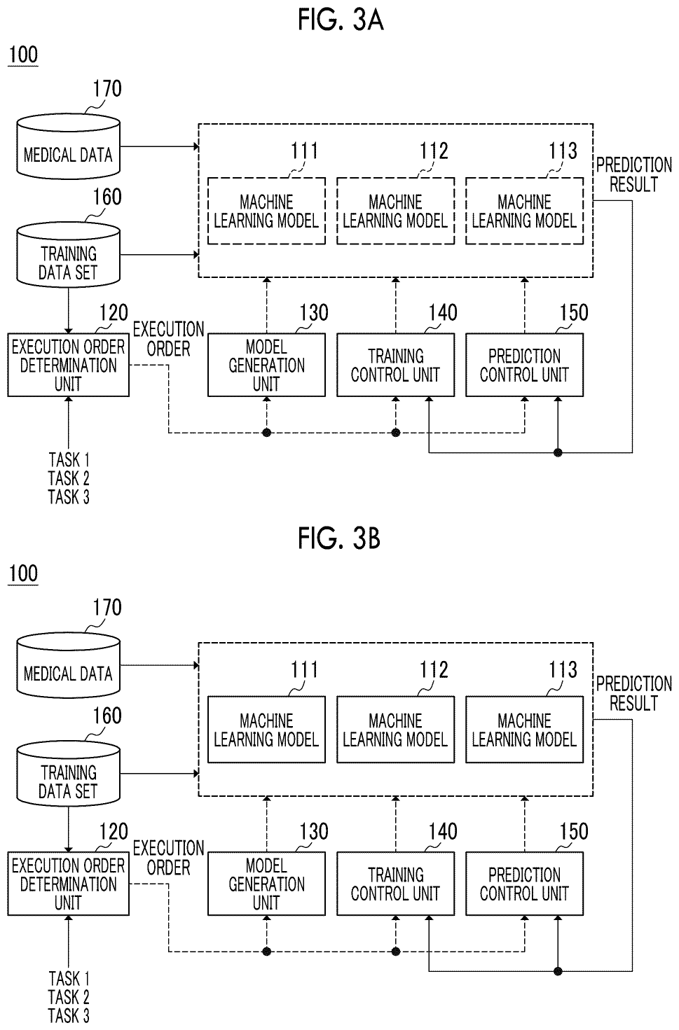

FIG. 3A and FIG. 3B are diagrams illustrating a functional configuration of the prediction server 100 according to the present exemplary embodiment 1. The prediction server 100 includes, as a functional configuration, an execution order determination unit 120, a model generation unit 130, a training control unit 140, and a prediction control unit 150.

In the present exemplary embodiment 1, the prediction server 100 determines an execution order of three tasks 1 to 3 defined in advance by a user or the like. The prediction server 100 determines an execution order of the tasks 1 to 3 such that the prediction accuracy of one or a plurality of tasks is improved under a condition that an output of at least one task is input to a task in a subsequent stage.

In a case in which the execution order of the tasks 1 to 3 is determined, the prediction server 100 generates machine learning models 111 to 113 for solving the tasks 1 to 3 based on the execution order. In an initial state of an operation of the prediction server 100, the machine learning models 111 to 113 are not generated. The machine learning models 111 to 113 are generated after the execution order of the tasks 1 to 3 is determined in a process of the operation of the prediction server 100. In order to express this point, the machine learning models 111 to 113 are drawn by dotted lines in FIG. 3A, and the machine learning models 111 to 113 are drawn by solid lines in FIG. 3B.

A training data set 160 and medical data 170 are input to the prediction server 100. The training data set 160 is a set of pieces of training data created based on pieces of medical data of past inpatients. The training data set 160 is used in a training phase for training the machine learning models 111 to 113. The medical data 170 is medical data of an inpatient of which a prognosis is desired to be predicted. The medical data 170 is used in an operation phase in which prediction is performed by using the trained machine learning models 111 to 113.

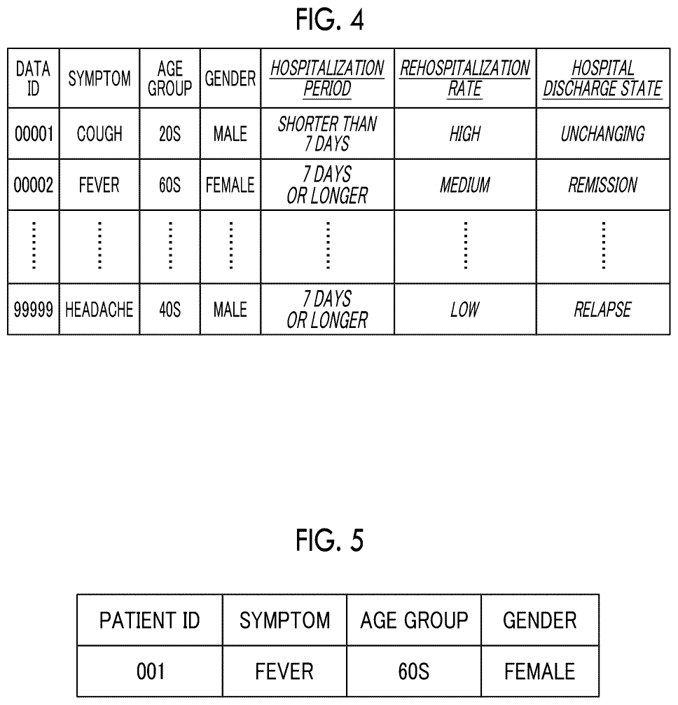

FIG. 4 is a diagram illustrating an example of the training data set 160 according to the present exemplary embodiment 1. Each of pieces of training data included in the training data set 160 includes a data identifier (ID), information related to “symptom”, “age group”, and “gender” of the inpatient, and “hospitalization period”, “rehospitalization rate”, and “hospital discharge state” as correct answer labels.

In the present example, the “symptom” takes any value of “cough”, “fever”, or “headache”. In the present example, the “age group” takes any value of “20s”, “40s”, or “60s”. In this example, the “gender” takes any value of “male” or “female”. In the present example, the “hospitalization period” as a correct answer label takes any value of “shorter than 7 days” or “7 days or longer”. In the present example, the “rehospitalization rate” as a correct answer label takes any value of “low”, “medium”, or “high”. In the present example, the “hospital discharge state” as a correct answer label takes any value of “unchanging”, “remission”, or “relapse”.

The training data set 160 includes 80% training data and 10% verification data. The training data is used in a case where the machine learning models 111 to 113 are trained. The verification data is used for evaluating the prediction accuracy in a process of training the machine learning models 111 to 113.

FIG. 5 is a diagram illustrating an example of the medical data 170 according to the present exemplary embodiment 1. The medical data 170 includes a patient ID, and information related to “symptom”, “age group”, and “gender” of the inpatient. Values that can be taken for “symptom”, “age group”, and “gender” are the same as the values in the training data set 160 described above.

### Execution Order Determination Unit 120

Returning to FIG. 3, the execution order determination unit 120 determines an execution order of the plurality of tasks based on the training data included in the training data set 160. In the present exemplary embodiment 1, the first task 1 is a task for predicting a “hospitalization period” of an inpatient. The second task 2 is a task for predicting a “rehospitalization rate” of an inpatient. The third task 3 is a task for predicting a “hospital discharge state” of an inpatient.

Further, the machine learning models 111 to 113 for solving the tasks 1 to 3 are generated by a model generation unit 130 to be described later. The execution order determination unit 120 determines an execution order of the tasks 1 to 3 such that the prediction accuracy of the one or the plurality of machine learning models is improved by inputting the output of at least one of the machine learning models to the machine learning model at a subsequent stage.

Specifically, the execution order determination unit 120 determines an execution order of the tasks 1 to 3 based on a statistical distribution of the correct answer label of the training data included in the training data set 160.

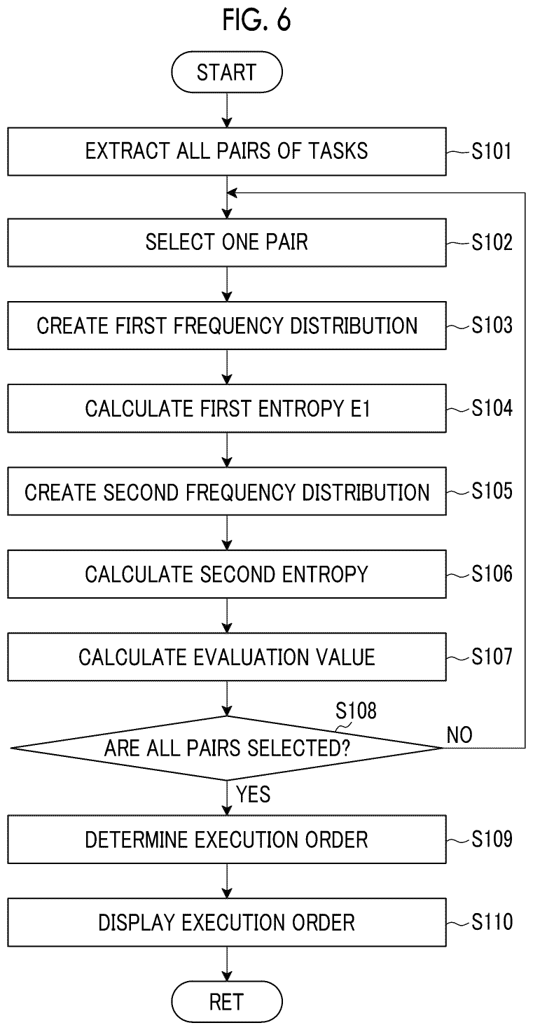

FIG. 6 is a flowchart illustrating details of processing that determines an execution order of the plurality of tasks and is performed by the execution order determination unit 120.

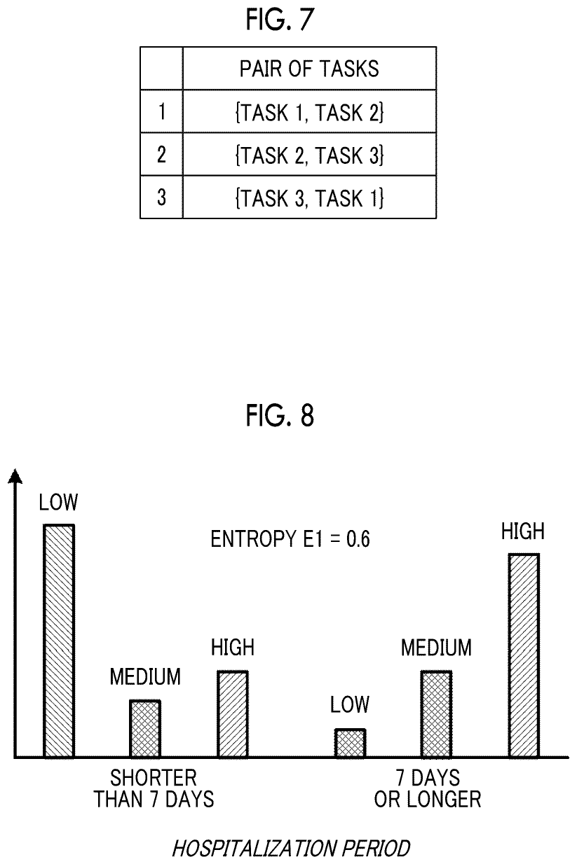

In step S101 of FIG. 6, the execution order determination unit 120 extracts all pairs that are considered for the plurality of tasks. Specifically, in a case where there are three tasks as in the present example, as illustrated in FIG. 7, a pair of the task 1 and the task 2, a pair of the task 2 and the task 3, and a pair of the task 3 and the task 1 are extracted.

In step S102, the execution order determination unit 120 selects one pair from the pairs of the tasks extracted in step S101. The execution order determination unit 120 sets one task of the selected pair as a first task, and sets the other task of the selected pair as a second task. For example, in a case where a pair in a first row of FIG. 7, that is, a pair of the task 1 and the task 2 is selected, the task 1 is set as a first task, and the task 2 is set as a second task.

In step S103, the execution order determination unit 120 creates, for the correct answer labels of the first task, a frequency distribution of the correct answer labels of the second task by using the training data included in the training data set 160, and sets the frequency distribution as a first frequency distribution.

For example, in a case where the task 1 is a first task and the task 2 is a second task, for correct answer labels “shorter than 7 days” and “7 days or longer” of the first task, a frequency distribution of the correct answer labels “low”, “medium”, and “high” is created, and the frequency distribution is set as the first frequency distribution. A histogram of the first frequency distribution is represented as illustrated in FIG. 8.

In step S104, the execution order determination unit 120 calculates, as an index of a bias of the first frequency distribution created in step S103, a first entropy E1 as a first statistic. Specifically, the first entropy E1 is calculated according to the following expression.

E1=ΣH1(i)·log(H1(i))

Here, in the above expression, H1(i) is a value of each frequency illustrated in FIG. 8, and a subscript i of Σ is a value from 1 to 6. In addition, a base of the logarithm log is 2. In the example of FIG. 8, the first entropy E1=0.6.

In step S105, the execution order determination unit 120 creates, for the correct answer labels of the second task, a frequency distribution of the correct answer labels of the first task by using the training data included in the training data set 160, and sets the frequency distribution as a second frequency distribution.

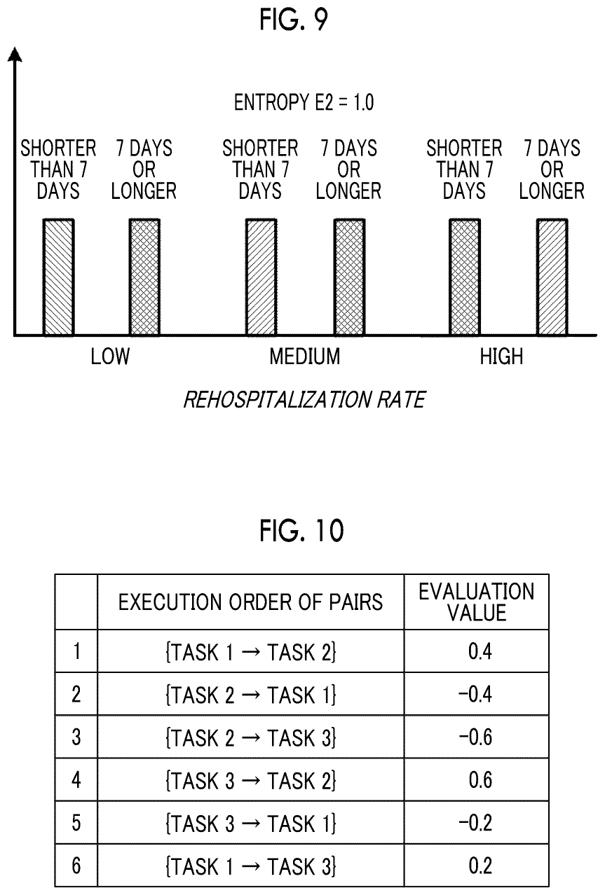

For example, in a case where the task 1 is a first task and the task 2 is a second task, for correct answer labels “low”, “medium”, and “high” of the second task, a frequency distribution of the correct answer labels “shorter than 7 days” and “7 days or longer” of the first task is created, and the frequency distribution is set as the second frequency distribution. A histogram of the second frequency distribution is represented as illustrated in FIG. 9.

In step S106, the execution order determination unit 120 calculates, as an index of a bias of the second frequency distribution created in step S105, a second entropy E2 as a second statistic. Specifically, the second entropy E2 is calculated according to the following expression.

E2=ΣH2(i)·log(H2(i))

Here, in the above expression, H2(i) is a value of each frequency illustrated in FIG. 9, and a subscript i of Σ is a value from 1 to 6. In addition, a base of the logarithm log is 2. In the example of FIG. 9, the second entropy E2=1.0.

In step S107, the execution order determination unit 120 calculates, based on the first entropy E1 and the second entropy E2, an evaluation value A in a case where the second task is executed after the first task and an evaluation value B in a case where the first task is executed after the second task, according to the following expression.

Evaluation value A=E2−E1

Evaluation value B=E1−E2

The execution order determination unit 120 creates an evaluation table as illustrated in FIG. 10 based on the evaluation values A and B calculated above.

In step S108, the execution order determination unit 120 determines whether or not processing of step S102 to step S107 described above is executed for all the pairs in FIG. 7.

In a case where processing of step S102 to step S107 is not executed for all the pairs in FIG. 7, the processing of the execution order determination unit 120 returns to step S102 described above. On the other hand, in a case where processing of step S102 to step S107 is executed for all the pairs in FIG. 7, the processing of the execution order determination unit 120 proceeds to next step S109.

In step S109, the execution order determination unit 120 determines, based on the evaluation table of FIG. 10, an execution order of the tasks 1 to 3 such that a total of the evaluation values has a highest value.

In the example of FIG. 10, a case of the execution order in which the total of the evaluation values has a highest value is a case where the task 3 is executed after the task 1 and the task 2 is executed after the task 3. Therefore, the execution order determination unit 120 determines the execution order of the tasks 1 to 3 to be an order of the task 1, the task 3, and the task 2.

In step S110, the execution order determination unit 120 displays the execution order of the tasks 1 to 3 that is determined in step S109 on the display unit 16.

By the above processing, the execution order of the tasks 1 to 3 is determined such that a total of prediction accuracies of the tasks 1 to 3 is maximized.

The reason why the execution order can be determined by the processing of the flowchart of FIG. 6 such that the total of the prediction accuracies of the plurality of tasks is maximized is as follows.

For example, it is assumed that there is a causal relationship between two events, “hospitalization period” and “rehospitalization rate”, such as “the rehospitalization rate increases as the hospitalization period is lengthened”. In this case, in a case where the task 1 for predicting the hospitalization period predicts that the hospitalization period is lengthened, the task 2 for predicting the rehospitalization rate can predict whether or not the rehospitalization rate increases on a premise that the hospitalization period is lengthened.

Further, in the case where there is a causal relationship between the two events, a bias of one of two frequency distributions corresponding to the two events should be increased. That is, a bias of a frequency distribution of a cause event is increased, and a bias of a frequency distribution of a result event is decreased. Note that, in a case where there is no causal relationship between the two events, there is a high possibility that both of the two frequency distributions are likely to be unbiased.

Therefore, in a case of determining an execution order of two tasks, executing a task with a larger bias in the frequency distribution first means executing a cause task first and executing a result task later. In addition, determining an execution order of a plurality of tasks such that a total of evaluation values of an execution order of a pair of the tasks has a highest value means performing predictions from a main cause to a final result by connecting these pairs of causal relationships.

### Model Generation Unit 130

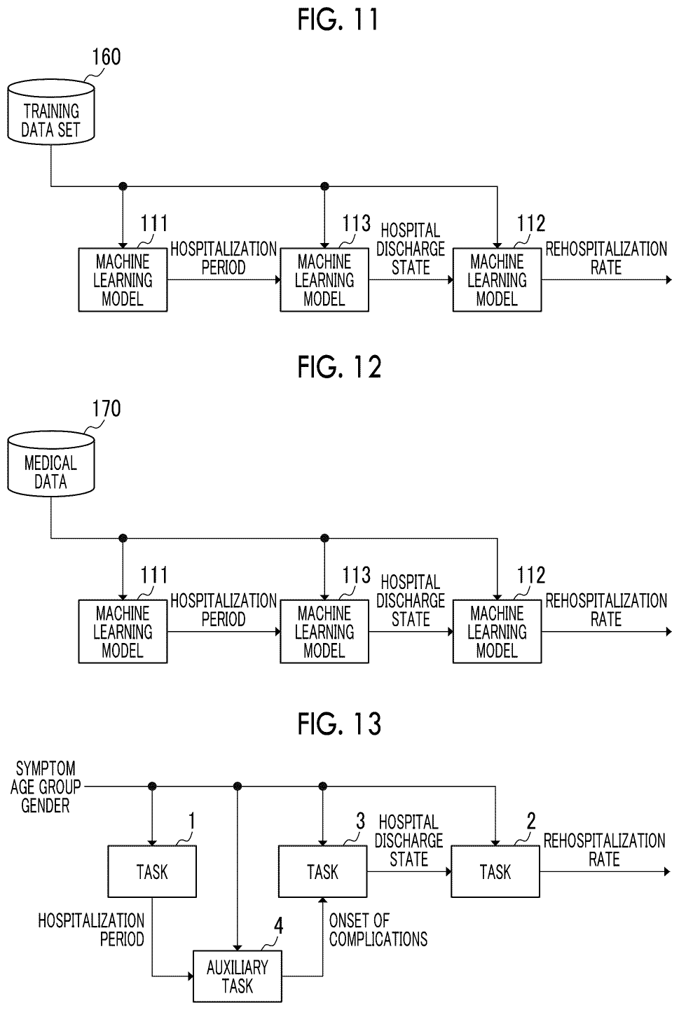

Returning to FIG. 3, the model generation unit 130 generates the machine learning models 111 to 113 for solving the tasks 1 to 3 based on the execution order of the tasks 1 to 3 that is determined by the execution order determination unit 120. Note that FIG. 11 and FIG. 12 are also referred to.

### Machine Learning Models 111 to 113

The machine learning models 111 to 113 are deep learning models based on a neural network. Each of the machine learning models 111 to 113 includes an input layer, one or a plurality of intermediate layers, and an output layer.

The machine learning model 111 that is executed first outputs “hospitalization period” in response to inputs of “symptom”, “age group”, and “gender” included in the training data set 160 or the medical data 170. The “hospitalization period” as a correct answer label that is included in the training data set 160 of FIG. 4 is a correct answer label corresponding to the machine learning model 111.

The machine learning model 113 that is executed second outputs “hospital discharge state” in response to inputs of “symptom”, “age group”, and “gender” included in the training data set 160 or the medical data 170 and “hospitalization period” output from the first machine learning model 111. The “hospital discharge state” as a correct answer label that is included in the training data set 160 of FIG. 4 is a correct answer label corresponding to the machine learning model 113.

The machine learning model 112 that is executed third outputs “rehospitalization rate” in response to inputs of “symptom”, “age group”, and “gender” included in the training data set 160 or the medical data 170 and “hospital discharge state” output from the second machine learning model 113. The “rehospitalization rate” as a correct answer label that is included in the training data set 160 of FIG. 4 is a correct answer label corresponding to the machine learning model 112.

### Training Control Unit 140

Returning to FIG. 3, the training control unit 140 connects and trains the machine learning models 111 to 113 generated by the model generation unit 130 according to the execution order determined by the execution order determination unit 120.

For example, as illustrated in FIG. 11, in a case where the execution order is determined as the order of the machine learning model 111, the machine learning model 113, and the machine learning model 112, training is performed as follows.

The training control unit 140 performs training such that the first machine learning model 111 can predict the “hospitalization period”, by using, as inputs, the training data included in the training data set 160, according to an error backward propagation method. In a training process of the first machine learning model 111, a weight and a bias of each neuron included in the machine learning model 111 are optimized.

In addition, the training control unit 140 performs training such that the second machine learning model 113 can predict the “hospital discharge state”, by using, as inputs, the training data included in the training data set 160 and the “hospitalization period” output from the first machine learning model 111, according to an error backward propagation method. In a training process of the second machine learning model 113, a weight and a bias of each neuron included in the machine learning model 113 are optimized.

In addition, the training control unit 140 performs training such that the third machine learning model 112 can predict the “rehospitalization rate”, by using, as inputs, the training data included in the training data set 160 and the “hospital discharge state” output from the second machine learning model 113, according to an error backward propagation method. In a training process of the third machine learning model 112, a weight and a bias of each neuron included in the machine learning model 112 are optimized.

In the training of the three machine learning models 111, 113, and 112, optimization of the weight and the bias of each neuron by the error backward propagation method is individually performed for each of the machine learning models 111, 113, and 112.

Specifically, the first machine learning model 111 outputs “hospitalization period” in response to an input of the training data. In addition, an error between the output and the correct answer label of the training data is backward propagated to the input layer of the first machine learning model, and thus the weight and the bias of each neuron included in the first machine learning model 111 are optimized.

Similarly, the second machine learning model 113 outputs “hospital discharge state” in response to inputs of the training data and the “hospitalization period” output by the first machine learning model 111. In addition, an error between the output and the correct answer label of the training data is backward propagated to the input layer of the second machine learning model, and thus the weight and the bias of each neuron included in the second machine learning model 113 are optimized.

Similarly, the third machine learning model 112 outputs “rehospitalization rate” in response to inputs of the training data and the “hospital discharge state” output by the second machine learning model 113. In addition, an error between the output and the correct answer label of the training data is backward propagated to the input layer of the third machine learning model, and thus the weight and the bias of each neuron included in the third machine learning model 112 are optimized.

Therefore, transfer of the output from the machine learning model in the previous stage to the machine learning model in the subsequent stage is sequentially performed. On the other hand, the optimization of each machine learning model by the error backward propagation method can be performed in parallel.

Note that, instead of using the error backward propagation method in the training, for example, a Gumbel-Softmax method may be used. In the Gumbel-Softmax method, even though the output of the machine learning model is a classification result, an error can be backward propagated to the machine learning model in the previous stage. In this case, an error between the output of the third machine learning model 112 and the correct answer label and an error between the output of the second machine learning model 113 and the correct answer label are backward propagated to the input layer of the first machine learning model 111. Thereby, it is possible to collectively optimize the weights and the biases of each neuron included in the three machine learning models 111, 113, and 112.

Further, in the training, after only the machine learning model in the previous stage is first trained and the trained machine learning model is confirmed, training of the machine learning model in the subsequent stage may be repeated. Thereby, the three machine learning models 111, 113, and 112 may be trained. Such a method is useful in a case of a model configuration in which the error backward propagation method or the Gumbel-Softmax method cannot be used. In addition, such a method can also be applied to models other than deep learning models based on a neural network.

### Prediction Control Unit 150

Returning to FIG. 3, the prediction control unit 150 connects the machine learning models 111 to 113 trained by the training control unit 140 according to the execution order determined by the execution order determination unit 120, that is, the trained machine learning models 111 to 113, and causes the trained machine learning models 111 to 113 to perform prediction.

For example, as illustrated in FIG. 12, in a case where the execution order is determined as the order of the machine learning model 111, the machine learning model 113, and the machine learning model 112, prediction is performed as follows.

The prediction control unit 150 inputs the medical data 170 of the inpatient to the first machine learning model 111. The first machine learning model 111 predicts and outputs a “hospitalization period” of the inpatient based on the “symptom”, the “age group”, and the “gender” included in the medical data 170.

Next, the prediction control unit 150 inputs the medical data 170 of the inpatient and the “hospitalization period” output from the first machine learning model 111 to the second machine learning model 113. The second machine learning model 113 predicts and outputs a “hospital discharge state” of an inpatient based on the “symptom”, the “age group”, and the “gender” included in the medical data 170, and the “hospitalization period” that is the output of the first machine learning model 111.

Finally, the prediction control unit 150 inputs the medical data 170 of the inpatient and the “hospital discharge state” output from the second machine learning model 113 to the third machine learning model 112. The third machine learning model 112 predicts and outputs a “rehospitalization rate” of an inpatient based on the “symptom”, the “age group”, and the “gender” included in the medical data 170, and the “hospital discharge state” that is the output of the second machine learning model 113.

As described above, the prediction server 100 according to the exemplary embodiment 1 of the present disclosure includes the execution order determination unit 120 that determines the execution order of the plurality of tasks. In other words, the prediction server 100 functions as a determination device of the execution order of the plurality of tasks.

The execution order determination device determines an execution order of a plurality of tasks under a condition that an output of at least one task is input to a task in a subsequent stage. Thereby, it is possible to determine an execution order of a plurality of tasks such that the prediction accuracy of one or a plurality of tasks is improved as compared with a case where each task is independently executed.

Further, the execution order determination device creates a frequency distribution of each correct answer label of each task by using the training data set 160, and determines the execution order of the plurality of tasks based on a bias of the frequency distribution. Thereby, it is possible to determine the execution order of the plurality of tasks based on a statistical property of the training data. Therefore, as compared with a case where machine learning models are actually generated and then the execution order of the machine learning models is determined, it is possible to quickly determine the execution order of the plurality of tasks.

In the exemplary embodiment 1, the execution order determination unit 120 calculates, in step S107 of FIG. 6, the evaluation value A=E2−E1 in a case where the second task is executed after the first task and the evaluation value B=E1−E2 in a case where the first task is executed after the second task, and then determines, in step S109, the execution order of each task such that the total of the evaluation values has a highest value. Such a determination method is intended to improve the overall prediction accuracy while minimizing a decrease in the prediction accuracy of each task.

Instead, in a case where it is intended to improve the overall prediction accuracy by further improving the prediction accuracy of a specific task while accepting a decrease in the prediction accuracy of some tasks, the following determination method may be adopted.

In this determination method, the execution order determination unit 120 calculates, in step S107 of FIG. 6, the evaluation value A in a case where the second task is executed after the first task and the evaluation value B in a case where the first task is executed after the second task, according to the following expression.

Evaluation value A=E1

Evaluation value B=E2

Thereafter, in step S109 of FIG. 6, the execution order determination unit 120 determines the execution order of each task such that the total of the evaluation values has a lowest value.

Further, in the exemplary embodiment 1, the execution order determination device can display the determined execution order on the display unit 16. Thereby, the user can recognize the order in which the plurality of tasks are executed.

The execution order determination device may determine the execution order of the plurality of tasks in consideration of the execution order designated by the user via the input unit 15. Thereby, it is possible to determine the execution order in which an intention of the user is reflected.

Further, in the exemplary embodiment 1, all the tasks 1 to 3 are defined in advance by the user or the like. Instead of this, the execution order determination device 120 may automatically define an auxiliary task for predicting information that is not determined at a time of performing the prediction among pieces of information which can be acquired from the pieces of medical data of past inpatients that are used in a case of creating the training data set 160.

For example, in the pieces of medical data of past inpatients that are used in a case of creating the training data set 160, it is assumed that 80% of the medical data includes information related to “onset of complications” during the hospitalization period. In addition, it is assumed that 20% of the medical data includes information related to “rehospitalization date” after a hospital discharge.

In the situation described above, the execution order determination unit 120 may automatically define, as an auxiliary task for predicting information that is not determined at a time of performing the prediction, that is, on the hospitalization date, an auxiliary task for predicting “onset of complications” during the hospitalization period and an auxiliary task for predicting “rehospitalization date” after a hospital discharge. Further, the information that is not determined at a time of performing the prediction includes, for example, information that can be acquired after an acquisition date of the input data to be used in a case where prediction is performed and before the corresponding date of the data which is a target of the task.

The auxiliary task for predicting the “onset of complications” during the hospitalization period predicts the “onset of complications” during the hospitalization period from the “symptom”, the “age group”, and the “gender” of the inpatient. The auxiliary task for predicting the “rehospitalization date” after a hospital discharge predicts the “rehospitalization date” after a hospital discharge from the “symptom”, the “age group”, and the “gender” of the inpatient.

By automatically defining the auxiliary task for predicting the “onset of complications” and the auxiliary task for predicting the “rehospitalization date”, the execution order determination unit 120 adds the “onset of complications” and the “rehospitalization date” as correct answer labels to the training data included in the training data set 160. The “onset of complications” and the “rehospitalization date” as the correct answer labels can be acquired by referring to the pieces of medical data of past inpatients that are used in a case of creating the training data set 160.

Here, as described above, in a case where the information related to “onset of complications” and “rehospitalization date” is not included in the pieces of medical data of all the past inpatients, the execution order determination unit 120 may define only the auxiliary task corresponding to the information included at a ratio equal to or higher than a predetermined threshold value. For example, in a case where the predetermined threshold value is 50%, the execution order determination unit 120 may automatically define only the auxiliary task for predicting “onset of complications”, and may not define the auxiliary task for predicting “rehospitalization date”.

FIG. 13 is a diagram illustrating an example of a result obtained by determining an execution order of tasks including an auxiliary task 4 for predicting “onset of complications”. The prediction result of the auxiliary task 4 which is automatically defined in this manner may not necessarily be presented to the user.

A learning method of the machine learning model for the auxiliary task will be specifically exemplified below.

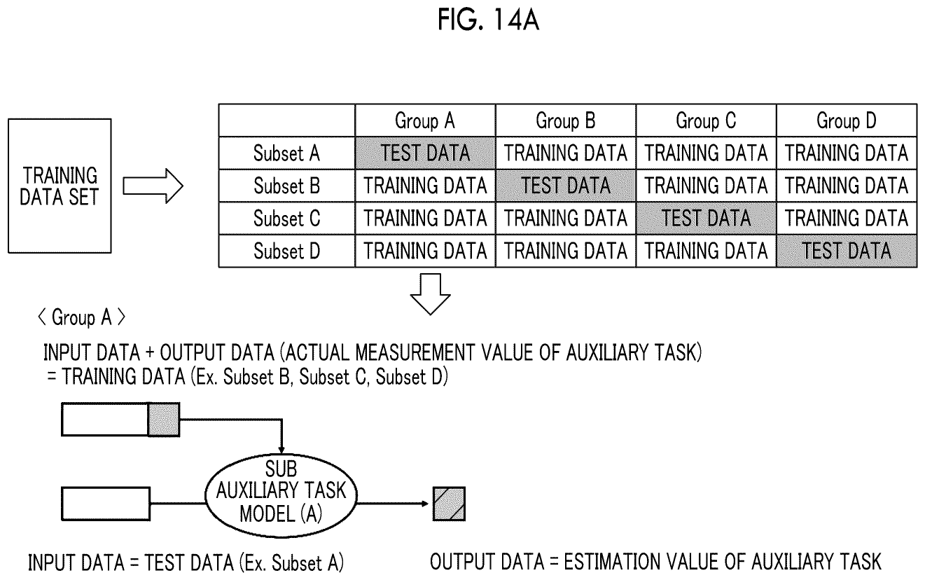

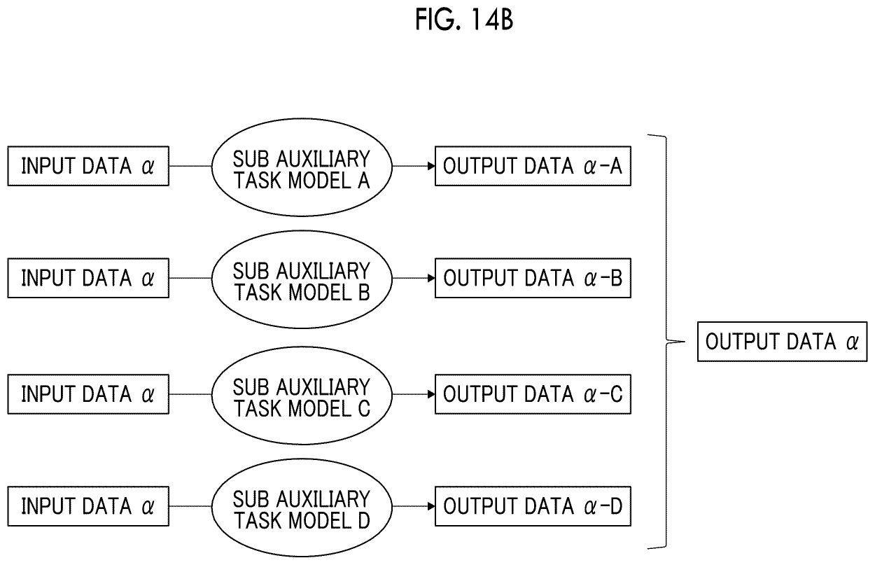

First, in the past medical data, pieces of medical data of inpatients that include actual measurement data corresponding to the auxiliary task are acquired as training data sets. Data for cross-verification is generated from these training data sets. More specifically, the training data is divided into a plurality of subsets, whether the training data is to be treated as test data or training data is determined for each subset, and a plurality of pieces of group data that are differently treated are created. For example, as described in FIG. 14A, the training data sets are divided into four subsets of a subset A, a subset B, a subset C, and a subset D. A group A that uses the subset A as test data, a group B that uses the subset B as test data, a group C that uses the subset C as test data, and a group D that uses the subset D as test data are generated. In the groups, subsets excluding the subset used as test data are used as training data. In the example, the number of divisions of the subsets is set to 4. On the other hand, the number of divisions is not limited thereto, and may be 2 or more. Further, a ratio of the test data to the training data in each group is also set to 1:3. On the other hand, the ratio is not particularly limited thereto, and may be set to 1:1.

Thereafter, a sub auxiliary task model is generated by performing training, for each group, based on the medical data that includes actual measurement data of the auxiliary task (for example, onset of complications) and is included in the training data. For example, in a case of the group A, training is performed by using, as inputs, pieces of medical data excluding data of the auxiliary task, such as “symptom”, “age group”, and “gender” included in the subsets B to D, and using, as an output, the actual measurement data of the auxiliary task (for example, onset of complications) included in the subsets B to D. Thereby, a sub auxiliary task model A is generated. Similarly, sub auxiliary task models B to D are generated for the groups B to D.

In an inference stage of the auxiliary task, as illustrated in FIG. 14B, the input data is input to each of these generated sub auxiliary task models A to D, and the auxiliary task is estimated based on each output result. More specifically, in a case of estimating the auxiliary task based on input data α, output data α-A which is an output result obtained by inputting the input data α to the sub auxiliary task model A, output data α-B which is an output result obtained by inputting the input data α to the sub auxiliary task model B, output data α-C which is an output result obtained by inputting the input data α to the sub auxiliary task model C, and output data α-D which is an output result obtained by inputting the input data α to the sub auxiliary task model D are obtained. An average value of these pieces of output data is used as an estimation value of the auxiliary task. In the present example, the average value of the output data α-A, the output data α-B, the output data α-C, and the output data α-D is used. On the other hand, the present invention is not limited thereto, and the output results of some sub auxiliary task models may be weighted according to results of the test data and the evaluation data.

Further, in a case where a machine learning model that estimates a task including an auxiliary task as an input is generated as in the task 3 of FIG. 13, an estimation value obtained by using the machine learning model of the auxiliary task is used as training data. Even in a case where a machine learning model that estimates a task including an auxiliary task as an input is generated, the machine learning model may be generated by using an actual measurement value of the auxiliary task. Here, in a case where only the actual measurement value of the auxiliary task is used, the actual measurement value is data with higher accuracy as compared with an estimation value obtained using the machine learning model of the auxiliary task. For this reason, the auxiliary task may be overly trusted. As a result, in a case where there is no actual measurement value of the auxiliary task and an estimation value obtained by using the machine learning model of the auxiliary task is input, performance may deteriorate. Thus, in a case where a machine learning model that estimates a task including an auxiliary task as an input is generated, it is preferable to use, as the training data, not only the actual measurement value of the auxiliary task but also an estimation value obtained by using at least the machine learning model of the auxiliary task. Alternatively, it is preferable to use only the estimation value obtained by using the machine learning model of the auxiliary task.

For the training data in a case of generating a machine learning model that estimates a task including an auxiliary task as an input, or for the input data in a case of estimating a task using the machine learning model, as data included in a training data set used in machine learning of the auxiliary task, the estimation value of the auxiliary task that is estimated in the machine learning of the auxiliary task may be used as well as other data. Specifically, for the subset A in FIG. 14A, the input data excluding the actual measurement value of the auxiliary task may be input to the sub auxiliary task models A to D, and an average value of output results may be used as the training data or input data. On the other hand, since the data included in the training data set used in the machine training of the auxiliary task is data used in the sub auxiliary task model during training, the accuracy will be higher as compared to data that is not used in training. For this reason, it is considered that the accuracy of the machine learning model that estimates a task including an auxiliary task as an input is affected. Therefore, for the data included in the training data set used in the machine learning of the auxiliary task, only the output result of the sub auxiliary task model, in which a subset including the data is test data, or a result obtained by setting a weight of the output result of the sub auxiliary task model to be higher than weights of the output results of other sub auxiliary task models may be used as the training data or the input data. Specifically, the estimation value of the auxiliary task for the data included in the subset A of FIG. 14A may be an output result value obtained by inputting data which does not include the actual measurement value of the auxiliary task to the sub auxiliary task model A in which the subset A is not included in the training data. Further, the present invention is not limited thereto. The estimation value of the auxiliary task for the data included in the subset A of FIG. 14A may be a value obtained by setting a weight of the output result of the sub auxiliary task model A to be higher than weights of the output results of the other sub auxiliary task models B to D.

Further, the prediction server 100 according to the exemplary embodiment 1 of the present disclosure includes the model generation unit 130 that generates a plurality of machine learning models for solving each of a plurality of tasks according to the execution order determined by the execution order determination unit 120. In other words, the prediction server 100 functions as a generation device for generating a plurality of machine learning models for solving each of a plurality of tasks according to the execution order determined by the execution order determination device.

Further, the prediction server 100 according to the exemplary embodiment 1 of the present disclosure includes the training control unit 140 that connects a plurality of machine learning models and performs training according to the execution order determined by the execution order determination unit 120. In other words, the prediction server 100 functions as a learning device that connects a plurality of machine learning models and performs training according to the execution order determined by the execution order determination device.

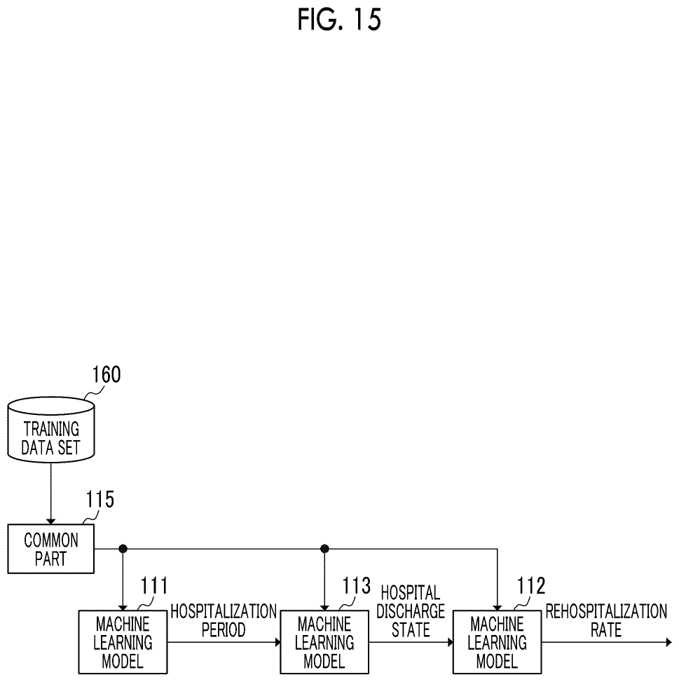

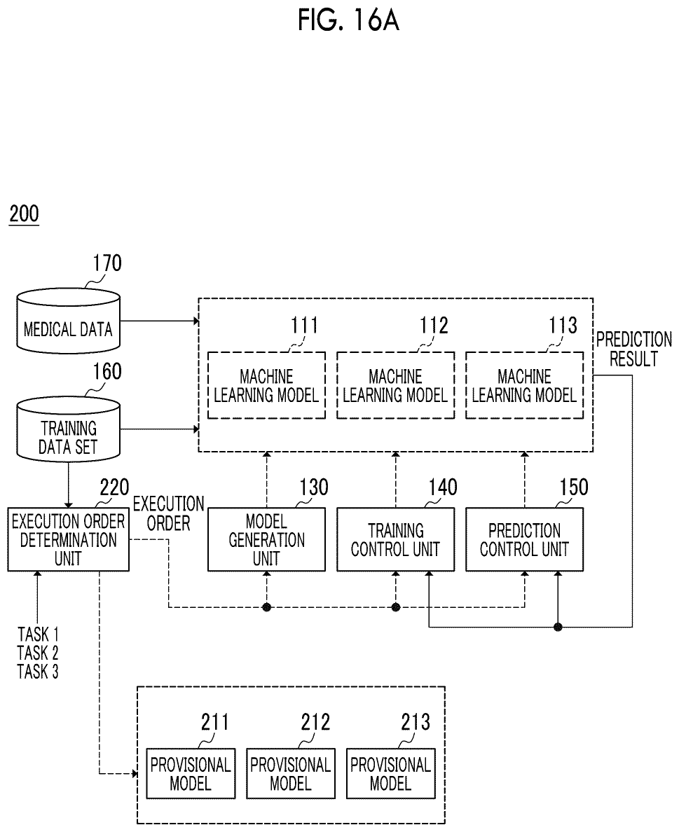

In a case where a common part is included in the plurality of machine learning models, the learning device may also combine and change a configuration of the common part in the training process. For example, as illustrated in FIG. 15, in a case where a common part 115 is included in the three machine learning models 111, 113, and 112, the learning device may combine and change a configuration of the common part 115 in the training process.

Further, the prediction server 100 according to the exemplary embodiment 1 of the present disclosure includes the prediction control unit 150 that connects a plurality of trained machine learning models and performs prediction according to the execution order determined by the execution order determination unit 120. In other words, the prediction server 100 functions as a prediction device that connects a plurality of trained machine learning models and performs prediction according to the execution order determined by the execution order determination device.

In the exemplary embodiment 1, the outputs of the machine learning models 111 to 113 are a result of classification. On the other hand, the outputs of the machine learning models 111 to 113 may be probability values obtained in a process of classification or numerical values obtained by regression. In this case, without using the Gumbel-Softmax method, by using a normal error backward propagation method, an error between the output of the third machine learning model 112 and the correct answer label and an error between the output of the second machine learning model 113 and the correct answer label are backward propagated to the input layer of the first machine learning model 111. Thereby, it is possible to collectively optimize the weights and the biases of each neuron included in the three machine learning models 111, 113, and 112.

### Exemplary Embodiment 2

Next, the prediction server 200 according to an exemplary embodiment 2 of the present disclosure will be described. Note that, in the following description, components that are the same as or similar to those in the exemplary embodiment 1 are denoted by the same reference numerals and a detailed description of the components will be omitted.

### Prediction Server 200

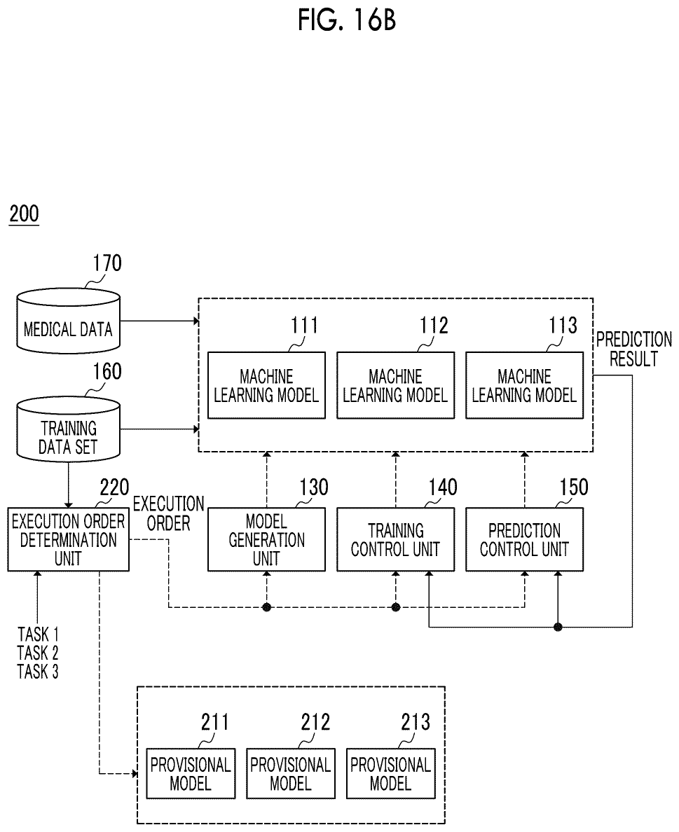

FIG. 16A and FIG. 16B are diagrams illustrating a configuration of the prediction server 200 according to an exemplary embodiment 2 of the present disclosure. In the prediction server 200, the execution order determination unit 120 included in the prediction server 100 according to the exemplary embodiment 1 is replaced with an execution order determination unit 220.

As in the exemplary embodiment 1, the machine learning models 111 to 113 are generated after the execution order of the tasks 1 to 3 is determined in a process of the operation of the prediction server 200. In order to express this point, the machine learning models 111 to 113 are drawn by dotted lines in FIG. 16A, and the machine learning models 111 to 113 are drawn by solid lines in FIG. 16B.

### Execution Order Determination Unit 220

The execution order determination unit 220 extracts a plurality of order patterns that are considered for the plurality of tasks, and generates a plurality of provisional models for solving each of the plurality of tasks according to the extracted order patterns. The execution order determination unit 220 determines an execution order of a plurality of tasks based on a result obtained by training the plurality of provisional models and evaluating prediction accuracy.

In the present exemplary embodiment 2, as in the exemplary embodiment 1, a case where the execution order of the three tasks 1 to 3 is determined will be described. As in the exemplary embodiment 1, the first task 1 is a task for predicting a “hospitalization period” of an inpatient. The second task 2 is a task for predicting a “rehospitalization rate” of an inpatient. The third task 3 is a task for predicting a “hospital discharge state” of an inpatient.

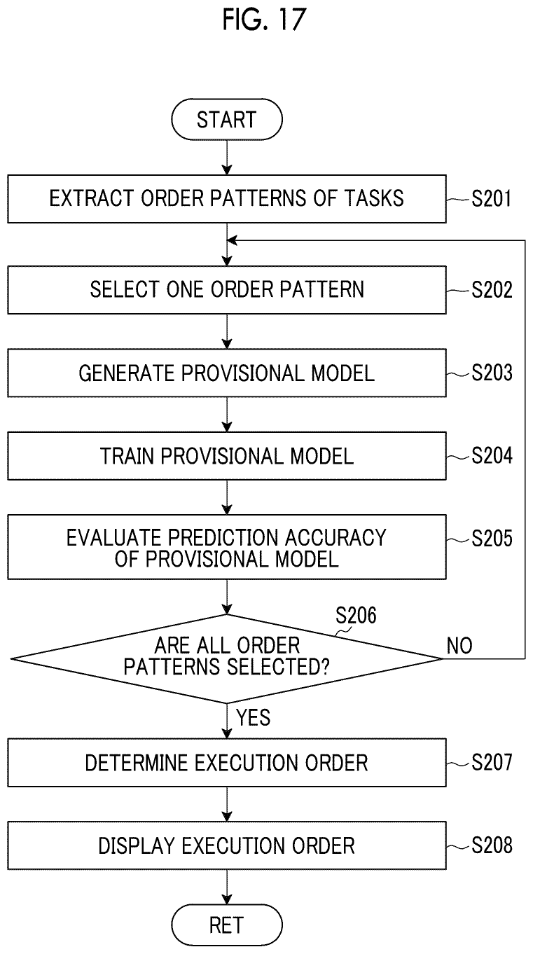

FIG. 17 is a flowchart illustrating details of processing that determines an execution order of the plurality of tasks and is performed by the execution order determination unit 220.

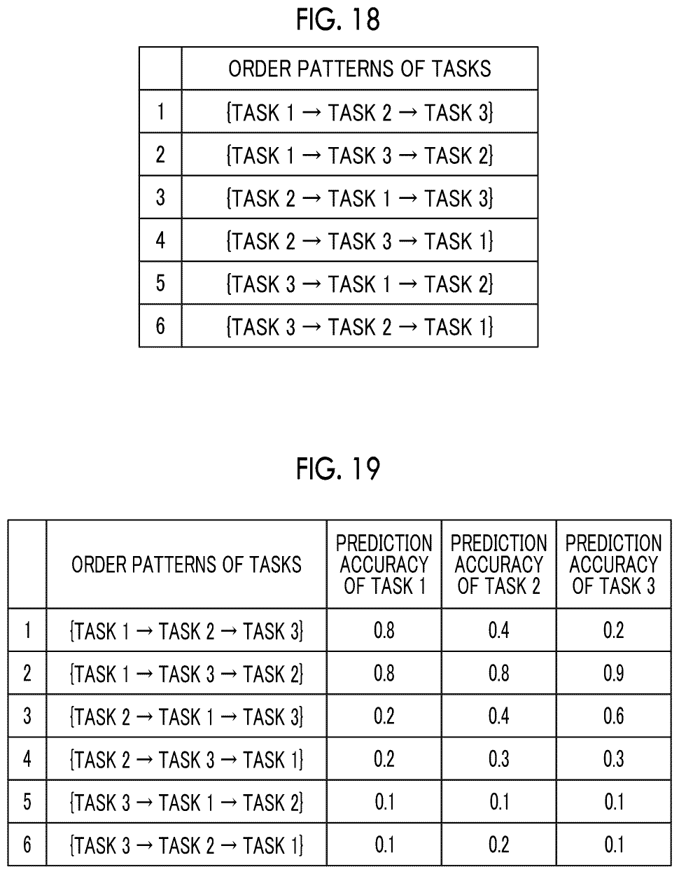

In step S201, the execution order determination unit 220 extracts a plurality of order patterns that are considered for the three tasks 1 to 3. For example, the extracted order patterns are as illustrated in FIG. 18. Other order patterns to be extracted can be considered. Here, for ease of description, six patterns illustrated in FIG. 18 will be described.

In step S202, the execution order determination unit 220 selects one order pattern from among the plurality of order patterns extracted in step S201. For example, the order pattern of a second row of FIG. 18 is selected.

In step S203, the execution order determination unit 220 generates provisional models 211 to 213 for respectively solving the tasks 1 to 3 based on the order pattern selected in step S202.

For example, in a case where the order pattern selected in step S202 is the order pattern of the second row of FIG. 18, that is, the order pattern of the task 1, the task 3, and the task 2, the following provisional models 211, 213, and 212 corresponding to the tasks are generated.

The first provisional model 211 outputs “hospitalization period” in response to inputs of “symptom”, “age group”, and “gender” included in the training data set 160. The “hospitalization period” as a correct answer label that is included in the training data set 160 of FIG. 4 is a correct answer label corresponding to the provisional model 211.

The second provisional model 213 outputs “hospital discharge state” in response to inputs of “symptom”, “age group”, and “gender” included in the training data set 160 and “hospitalization period” output from the first provisional model 211. The “hospital discharge state” as a correct answer label that is included in the training data set 160 of FIG. 4 is a correct answer label corresponding to the provisional model 213.

The third provisional model 212 outputs “rehospitalization rate” in response to inputs of “symptom”, “age group”, and “gender” included in the training data set 160 and “hospital discharge state” output from the second provisional model 213. The “rehospitalization rate” as a correct answer label that is included in the training data set 160 of FIG. 4 is a correct answer label corresponding to the provisional model 212.

In step S204, the execution order determination unit 220 connects and trains the provisional models 211, 213, and 212 generated in step S203 according to the order pattern selected in step S202. In this case, the training data included in the training data set 160 is used.

In step S205, the execution order determination unit 220 connects the provisional models 211, 213, and 212 trained in step 204, and evaluates the prediction accuracy of each of the provisional models 211, 212, and 213. The execution order determination unit 220 creates an evaluation table as illustrated in FIG. 19 based on an evaluation result of the prediction accuracy. In this case, the verification data included in the training data set 160 is used.

In step S206, the execution order determination unit 220 determines whether or not processing of step S202 to step S205 described above is executed for all the order patterns in FIG. 18.

In a case where processing of step S202 to step S205 is not executed for all the order patterns in FIG. 18, the processing of the execution order determination unit 220 returns to step S202 described above. On the other hand, in a case where processing of step S202 to step S205 is executed for all the order patterns in FIG. 18, the processing of the execution order determination unit 220 proceeds to next step S207.

In step S207, the execution order determination unit 220 selects an order pattern in which a weighted total value of the prediction accuracies calculated according to the following expression is highest, based on the evaluation table of FIG. 19.

Accuracy_total=ΣCi*Accuracy_i

Here, in the above expression, Accuracy_i is prediction accuracy of a task i, and a subscript i is a value from 1 to 3. Further, a coefficient Ci is importance of the task i, and satisfies 0<Ci<1 and ΣCi=1.

In FIG. 19, for example, in a case where C1=C2=C3=⅓, the order pattern in which the weighted total value of the prediction accuracies is highest is the order pattern of the second row, that is, the order pattern of the task 1, the task 3, and the task 2. Therefore, the execution order determination unit 220 determines the execution order of the tasks 1 to 3 to be an order of the task 1, the task 3, and the task 2.

In step S208, the execution order determination unit 220 displays the execution order of the tasks 1 to 3 that is determined in step S207 on the display unit 16.

By the above processing, the execution order of the tasks 1 to 3 is determined such that the weighted total value of the prediction accuracies of the tasks 1 to 3 is highest.

As described above, the execution order determination device according to the exemplary embodiment 2 of the present disclosure extracts a plurality of order patterns that are considered for the plurality of tasks, and generates a plurality of provisional models for solving each of the plurality of tasks according to the extracted order patterns. The execution order determination device determines an execution order of a plurality of tasks based on a result obtained by training the plurality of provisional models and evaluating prediction accuracy. Thereby, it is guaranteed that high prediction accuracy is obtained by executing the plurality of tasks according to the determined execution order.

In the training processing in step S204 of the flowchart of FIG. 17, instead of inputting the output of the provisional model in a previous stage to the provisional model in a subsequent stage, a correct answer label corresponding to the output of the provisional model in a previous stage may be input to the provisional model in a subsequent stage.

Further, in the exemplary embodiments, for example, the following various processors can be used as a hardware structure of processing units performing various processes, such as the execution order determination unit, the model generation unit, the training control unit, and the prediction control unit. Various processors include a programmable logic device (PLD) that is capable of changing a circuit configuration after manufacturing, such as a field-programmable gate array (FPGA), and a dedicated electric circuit that is a processor having a circuit configuration dedicatedly designed for executing specific processing, such as an application specific integrated circuit (ASIC), in addition to a CPU that is a general-purpose processor configured to execute software (program) to function as various processing units.

The various pieces of processing may be executed by one of the various processors or a combination of two or more processors of the same type or different types (for example, a plurality of FPGAs and a combination of CPU and FPGA). Further, the plurality of processing units may be configured by one processor. As an example where a plurality of processing units are configured with one processor, like system-on-chip (SOC), there is a form in which a processor that realizes all functions of a system including a plurality of processing units into one integrated circuit (IC) chip is used.

In this manner, the various processing units are configured by using one or more various processors as a hardware structure.

In addition, as the hardware structure of various processors, more specifically, an electric circuit (circuitry), in which circuit elements, such as semiconductor elements, are combined can be used.

Further, the technique of the present disclosure is applied to not only an operation program of a data merging rule generation device, an operation program of a learning device, and an operation program of an imaging device but also a non-transitory computer readable storage medium (a USB memory, a digital versatile disc (DVD)-read only memory (ROM), or the like) storing the operation program of the imaging device.

The entire disclosure of Japanese Patent Application No. 2021-137516 filed on Aug. 25, 2021 is incorporated into the present specification by reference.

All literatures, patent applications, and technical standards described in the present specification are incorporated in the present specification by reference to the same extent as in a case where the individual literatures, patent applications, and technical standards are specifically and individually stated to be incorporated by reference.

What is claimed is:

1. A device for determining an execution order of a plurality of tasks, the device comprising:
a processor; and
a memory connected to or built in the processor, the processor being configured to:
execute execution order determination processing of determining an execution order of the plurality of tasks under a condition that an output of at least one task of the tasks is input to the task in a subsequent stage.

2. The device for determining an execution order according to claim 1, wherein:
the plurality of tasks include a first task and a second task, and
in the execution order determination processing, the processor is configured to:
create, for each of correct answer labels of the first task, a frequency distribution of each of correct answer labels of the second task by using a training data set, and calculate a first statistic based on the frequency distribution;
create, for each of the correct answer labels of the second task, a frequency distribution of each of the correct answer labels of the first task by using a training data set, and calculate a second statistic based on the frequency distribution; and
determine the execution order of the plurality of tasks based on the first statistic and the second statistic.

3. The device for determining an execution order according to claim 1, wherein, in the execution order determination processing, the processor is configured to:
extract a plurality of order patterns that are considered for the plurality of tasks;
generate a plurality of provisional models for respectively solving the plurality of tasks according to each of the extracted order patterns; and
determine the execution order of the plurality of tasks based on a result obtained by training the plurality of provisional models and evaluating prediction accuracy.

4. The device for determining an execution order according to claim 3, wherein, in the execution order determination processing, the processor is configured to, in a case of training the plurality of provisional models, input an output of at least one provisional model of the provisional models to the provisional model in a subsequent stage.

5. The device for determining an execution order according to claim 3, wherein, in the execution order determination processing, the processor is configured to, in a case of training the plurality of provisional models, input a correct answer label corresponding to an output of at least one provisional model of the provisional models to the provisional model in a subsequent stage.

6. The device for determining an execution order according to claim 1, wherein the processor is configured to further execute display processing of displaying the execution order on a display unit.

7. The device for determining an execution order according to claim 1, wherein, in the execution order determination processing, the processor is configured to determine the execution order in consideration of an execution order designated by a user.

8. The device for determining an execution order according to claim 1, wherein, in the execution order determination processing, the processor is configured to automatically define an auxiliary task for predicting information that is not determined at a time of performing prediction.

9. The device for determining an execution order according to claim 1, wherein the output of at least one task of the tasks is a numerical value obtained by regression.

10. The device for determining an execution order according to claim 1, wherein the output of at least one task of the tasks is a result of classification.

11. The device for determining an execution order according to claim 1, wherein the output of at least one task of the tasks is a probability value obtained in a classification process.

12. A device for generating a plurality of machine learning models, the device comprising:
a processor; and
a memory connected to or built in the processor, the processor being configured to:
execute model generation processing of generating a plurality of machine learning models for respectively solving the plurality of tasks according to the execution order determined by the device for determining an execution order according to claim 1.

13. A learning device of a plurality of machine learning models, the device comprising:
a processor; and
a memory connected to or built in the processor, the processor being configured to:
execute training processing of connecting and training the plurality of machine learning models according to the execution order determined by the device for determining an execution order according to claim 1.

14. The learning device according to claim 13, wherein:
the plurality of machine learning models are based on a neural network, and
in the training processing, the processor is configured to train the plurality of machine learning models while propagating an error of the machine learning model in a subsequent stage to the machine learning model in a previous stage.

15. The learning device according to claim 13, wherein:
the plurality of machine learning models are based on a neural network, and
in the training processing, the processor is configured to train the plurality of machine learning models without propagating an error of the machine learning model in a subsequent stage to the machine learning model in a previous stage.

16. The learning device according to claim 13, wherein, in the training processing, the processor is configured to train the machine learning model in a subsequent stage after training the machine learning model in a previous stage and confirming the machine learning model.

17. The learning device according to claim 13, wherein:
the plurality of machine learning models include a common model, and
in the training processing, the processor is configured to combine and change a configuration of the common model.

18. A prediction device of a plurality of machine learning models, the device comprising:
a processor; and
a memory connected to or built in the processor, the processor being configured to:
execute prediction processing of connecting the plurality of machine learning models and causing the plurality of machine learning models to perform prediction according to the execution order determined by the device for determining an execution order according to claim 1.

19. An operation method for a device for determining an execution order of a plurality of tasks, the method comprising:
a step of determining an execution order of the plurality of tasks under a condition that an output of at least one task of the tasks is input to the task in a subsequent stage.

20. A non-transitory computer readable medium storing a program for determining an execution order of a plurality of tasks, the program causing a computer to execute a process comprising:
a step of determining an execution order of the plurality of tasks under a condition that an output of at least one task of the tasks is input to the task in a subsequent stage.
